(19) United States
(12) Patent Application Publication
(10) Pub. No.: US 2026/0351666 A1
(43) Pub. Date: Nov. 5, 2026

(54) ALL-SOLID-STATE SECONDARY BATTERY

(71) Applicant: SAMSUNG SDI CO., LTD., Yongin-si, Gyeonggi-do (KR)

(72) Inventors: Sang Il YI, Yongin-si, Gyeonggi-do (KR); Hyeoksoo HONG, Yongin-si, Gyeonggi-do (KR); Seongseop KIM, Yongin-si, Gyeonggi-do (KR); Dongwoo KIM, Yongin-si, Gyeonggi-do (KR)

(21) Appl. No.: 18/776,448

(22) Filed: Jul. 18, 2024

(30) Foreign Application Priority Data
Jul. 21, 2023 (KR) 10-2023-0095583

(51) Int. Cl. H01M 10/0562; H01M 10/0585; H01M 50/449

(52) U.S. Cl. CPC H01M 10/0562; H01M 10/0585; H01M 50/449

(57) ABSTRACT

An all-solid-state secondary battery includes a first unit cell including a first lower current-collecting layer, a first solid electrolyte layer, and a first upper current-collecting layer stacked in a first direction; and a second unit cell positioned on the first upper current-collecting layer of the first unit cell and including a second lower current-collecting layer, a second solid electrolyte layer, and a second upper current-collecting layer stacked in the first direction, wherein the first upper current-collecting layer includes a first upper extension portion extending in a second direction intersecting with the first direction, and wherein the second lower current-collecting layer includes a second lower extension portion extending in the second direction and welded to the first upper extension portion.

### CROSS-REFERENCE TO RELATED APPLICATION

This application claims priority to and the benefit of Korean Patent Application No. 10-2023-0095583, filed in the Korean Intellectual Property Office on Jul. 21, 2023, the entire contents of which are incorporated herein by reference.

### BACKGROUND

### 1. Field

Embodiments relate to an all-solid-state secondary battery.

### 2. Description of the Related Art

Recently, as the explosion risk of batteries using liquid electrolytes has been reported, development of all-solid-state secondary batteries is being conducted. An all-solid-state secondary battery is a battery in which all materials are made of solid, and refers to a battery in which a solid electrolyte is used. The all-solid-state secondary battery may be safe because there is no risk of explosion due to leakage of an electrolyte solution, and the battery is easy to manufacture as a thin battery.

### SUMMARY

Aspects of embodiments provide an all-solid-state secondary battery, including a first unit cell including a first lower current-collecting layer, a first solid electrolyte layer, and a first upper current-collecting layer stacked in a first direction, and a second unit cell positioned on the first upper current-collecting layer of the first unit cell and including a second lower current-collecting layer, a second solid electrolyte layer, and a second upper current-collecting layer stacked in the first direction, wherein the first upper current-collecting layer includes a first upper extension portion extending in a second direction intersecting with the first direction, and wherein the second lower current-collecting layer includes a second lower extension portion extending in the second direction and welded to the first upper extension portion.

The first upper extension portion may not overlap the first solid electrolyte layer and the second solid electrolyte layer in the first direction, and the second lower extension portion may not overlap the first solid electrolyte layer and the second solid electrolyte layer in the first direction.

The first upper current-collecting layer may further include a first upper overlapping portion extending from the first upper extension portion into a space between the first solid electrolyte layer and the second solid electrolyte layer, and the second lower current-collecting layer may further include a second lower overlapping portion extending from the second lower extension portion into the space between the first solid electrolyte layer and the second solid electrolyte layer and overlapping the first upper overlapping portion in the first direction.

The first upper overlapping portion of the first upper current-collecting layer may be in contact with the second lower overlapping portion of the second lower current-collecting layer.

The first upper overlapping portion of the first upper current-collecting layer and the second lower overlapping portion of the second lower current-collecting layer may not be welded to each other.

The all-solid-state secondary battery may further include an elastic sheet positioned between the first upper overlapping portion of the first upper current-collecting layer and the second lower overlapping portion of the second lower current-collecting layer.

The elastic sheet may be in contact with the first upper overlapping portion of the first upper current-collecting layer and the second lower overlapping portion of the second lower current-collecting layer.

The all-solid-state secondary battery may further include a third unit cell positioned on the second upper current-collecting layer of the second unit cell and including a third lower current-collecting layer, a third solid electrolyte layer, and a third upper current-collecting layer stacked in the first direction, the second upper current-collecting layer may include a second upper extension portion extending in the second direction, and the third lower current-collecting layer may include a third lower extension portion extending in the second direction and welded to the second upper extension portion.

The second upper extension portion and the third lower extension portion may extend in an opposite direction to the first upper extension portion and the second lower extension portion with respect to the second direction.

The first lower current-collecting layer, the second upper current-collecting layer, and the third lower current-collecting layer may have the same first polarity, and the first upper current-collecting layer, the second lower current-collecting layer, and the third upper current-collecting layer may have the same second polarity.

The first unit cell, the second unit cell, and the third unit cell may form a bi-cell structure.

The first lower current-collecting layer, the second lower current-collecting layer, and the third lower current-collecting layer may have the same first polarity, and the first upper current-collecting layer, the second upper current-collecting layer, and the third upper current-collecting layer may have the same second polarity.

The first unit cell, the second unit cell, and the third unit cell may form a bipolar cell structure.

The second unit cell may further include a positive electrode active material layer positioned between the second lower current-collecting layer and the second solid electrolyte layer, a negative electrode coating layer positioned between the second solid electrolyte layer and the second upper current-collecting layer, a first inclined surface extending from one end portion of the second lower current-collecting layer to one end portion of the second solid electrolyte layer, a second inclined surface extending from the other end portion of the second lower current-collecting layer to the other end portion of the second solid electrolyte layer, a third inclined surface extending from one end portion of the second upper current-collecting layer to the one end portion of the second solid electrolyte layer, and a fourth inclined surface extending from the other end portion of the second upper current-collecting layer to the other end portion of the second solid electrolyte layer.

An area of an interface between the second upper current-collecting layer and the negative electrode coating layer may be greater than an area of the positive electrode active material layer.

The area of the interface between the second upper current-collecting layer and the negative electrode coating layer may be greater than an area of the second lower current-collecting layer.

During charging, a lithium metal layer may be formed between the second upper current-collecting layer and the negative electrode coating layer.

An area of the lithium metal layer may be greater than the area of the positive electrode active material layer.

The area of the lithium metal layer may be greater than the area of the second lower current-collecting layer.

One end portion of the lithium metal layer may divide the third inclined surface, and the other end portion of the lithium metal layer may divide the fourth inclined surface.

### BRIEF DESCRIPTION OF THE DRAWINGS

Features will become apparent to those of skill in the art by describing in detail exemplary embodiments with reference to the attached drawings, in which:

FIG. 1 is a cross-sectional view of an all-solid-state battery.

FIG. 2 is a cross-sectional view of an all-solid-state battery including a precipitation-type negative electrode.

FIG. 3 is a longitudinal cross-sectional view showing the front of an all-solid-state secondary battery according to an embodiment.

FIG. 4 is a longitudinal cross-sectional view showing a side of the all-solid-state secondary battery according to the embodiment.

FIG. 5 is a longitudinal cross-sectional view showing a second unit cell of the all-solid-state secondary battery according to the embodiment.

FIG. 6 is longitudinal cross-sectional views showing formation of a lithium metal layer in a second unit cell of the all-solid-state secondary battery according to the embodiment.

FIG. 7 is a longitudinal cross-sectional view showing an example of the second unit cell of the all-solid-state secondary battery according to the embodiment.

FIG. 8 is a longitudinal cross-sectional view showing another example of the second unit cell of the all-solid-state secondary battery according to the embodiment.

FIG. 9 is a longitudinal cross-sectional view showing still another example of the second unit cell of the all-solid-state secondary battery according to the embodiment.

FIG. 10 is a longitudinal cross-sectional view showing a side of an all-solid-state secondary battery according to another embodiment.

FIG. 11 is a longitudinal cross-sectional view showing a side of an all-solid-state secondary battery according to still another embodiment.

FIG. 12 is a longitudinal cross-sectional view showing a side of an all-solid-state secondary battery according to yet another embodiment.

FIG. 13 is a longitudinal cross-sectional view showing a side of an all-solid-state secondary battery according to still yet another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise”, and variations such as “comprises” or “comprising”, will be understood to imply the inclusion of stated elements but not the exclusion of any other elements.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

### Positive Electrode for All-Solid-State Secondary Battery

In an embodiment, there is provided a positive electrode for an all-solid-state secondary battery including a current collector and a first positive electrode active material layer positioned on the current collector. The first positive electrode active material layer may include a positive electrode active material, a sulfide solid electrolyte, a fluorine resin binder, and a vanadium oxide. The positive electrode for an all-solid-state secondary battery may be manufactured by applying a positive electrode composition including a positive electrode active material, a sulfide solid electrolyte, a fluorine resin binder, and a vanadium oxide to a current collector, followed by drying and roll-pressing.

The positive electrode composition may potentially become strongly basic due to residual lithium, e.g., LiOH, or other components, which may cause gelation or agglomeration of the fluorine resin binder. However, according to an embodiment, if a vanadium oxide is added, gelation of the fluorine resin binder is suppressed, and accordingly, the viscosity of the positive electrode composition is maintained, thereby ensuring processibility. Furthermore, there is no need to use a neutralizing agent, and the like, so deterioration of the sulfide solid electrolyte due to the neutralizing agent can be prevented, thereby improving performance of the all-solid-state secondary battery.

### Vanadium Oxide

The vanadium oxide is a component that is insoluble in a solvent of the positive electrode composition, and may control the strong basicity of the positive electrode composition to prevent gelation of the fluorine resin binder, and at the same time, suppress deterioration of the sulfide solid electrolyte to improve the ionic conductivity of the positive electrode. It is understood that the vanadium oxide controls pH through physical and/or chemical reactions with —OH groups in the positive electrode composition in a strong base state, and accordingly, suppresses gelation of the fluorine resin binder. Compared to other transition metal oxides, e.g., titanium oxide and tungsten oxide, the vanadium oxide has a more excellent ability to control basicity and suppress gelation of the fluorine resin binder, has low reactivity with the sulfide solid electrolyte, and may suppress deterioration of the sulfide solid electrolyte to improve the ionic conductivity and overall performance of the all-solid-state secondary battery.

The vanadium oxide may include, e.g., V₂O₃, VO₂, V₂O₄, V₂O₅, or a combination thereof. In addition, the vanadium oxide may be included in an amount of 0.01 wt % to 5 wt % with respect to 100 wt % of the first positive electrode active material layer, e.g., 0.05 wt % to 5 wt %, 0.1 wt % to 5 wt %, 0.5 wt % to 5 wt %, or 0.5 wt % to 3 wt %. If the vanadium oxide is included in the aforementioned amount, the viscosity of the positive electrode composition may be appropriately maintained without deterioration in capacity, thereby improving processibility and improving the ionic conductivity of the positive electrode.

According to an embodiment, the positive electrode composition may be coated on the current collector in a state in which the vanadium oxide is added and dispersed in the positive electrode composition. Therefore, the vanadium oxide may be in the form of being dispersed in the manufactured first positive electrode active material layer. This is different from a form in which the vanadium oxide is coated on a surface of the positive electrode active material or sulfide solid electrolyte.

In one example, the vanadium oxide may be a pentavalent vanadium oxide (vanadium (V) oxide), in which case the melting point of the vanadium oxide may be 1000 °C or lower, e.g., 600 °C to 800 °C or 650 °C to 690 °C. The pentavalent vanadium oxide is excellent in terms of suppressing gelation of the fluorine resin binder in the positive electrode and is advantageous for improving the overall battery performance.

In addition, the vanadium oxide may be in the form of a particle, and an average particle diameter (D50) thereof may be 10 nm to 10 μm, e.g., 10 nm to 5 μm, 10 nm to 3μm, 50 nm to 1 μm, 50 nm to 500 nm, or 500 nm to 1 μm. The vanadium oxide with these physical properties is suitable for addition to the positive electrode composition and may effectively suppress gelation of the positive electrode composition without adversely affecting the positive electrode. If the particle diameter of the vanadium oxide is too small, the vanadium oxide may not be properly dispersed in the positive electrode, blocking migration paths of electrons and ions, which may deteriorate the battery performance, or may not sufficiently perform its role to suppress gelation of the binder. On the other hand, if the particle diameter of the vanadium oxide is too large, the vanadium oxide may block the migration paths of electrons and ions, deteriorating the battery performance.

### Fluorine Resin Binder

The fluorine resin binder may be a general resin binder containing fluorine, and may include, e.g., polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or a combination thereof.

A weight average molecular weight of the fluorine resin binder may be approximately 50 kDa to 5,000 kDa, or 100 kDa to 2000 kDa. In addition, the glass transition temperature of the fluorine resin binder may be −10 °C or lower, and the melting point thereof may be 100 °C or higher. The melting viscosity of the fluorine resin binder may be about 10 kP to 50 kP. Furthermore, the fluorine resin binder may be in the form of a particle and an average particle diameter thereof may be approximately 50 nm to 200 μm. The fluorine resin binder with these physical properties can implement excellent adhesive force even if it is added to the positive electrode composition in a small amount and can increase the durability of the battery without adversely affecting the battery performance.

The fluorine resin binder may be included in an amount of 0.1 wt % to 10 wt %, e.g., 0.1 wt % to 8 wt %, 0.1 wt % to 6 wt %, 0.1 wt % to 5 wt %, 0.5 wt % to 4 wt %, or 1 wt % to 3 wt %, with respect to 100 wt % of the first positive electrode active material layer. If the fluorine resin binder is included in the above content range, excellent adhesive force can be exhibited without adversely affecting the positive electrode.

### Positive Electrode Active Material

The positive electrode active material can be applied without limitation as long as it is commonly used for all-solid-state secondary batteries. For example, the positive electrode active material may be a compound capable of reversible intercalation and deintercalation of lithium and may include a compound represented by any of the following chemical formulas.
LiₐA_{1-b}X_{b}D₂ (0.90≤a≤1.8, 0≤b≤0.5);
LiₐA_{1-b}X_{b}O_{2-c}D_{c} (0.90≤a≤1.8, 0≤b≤0.5, 0≤c≤0.05);
LiₐE_{1-b}X_{b}O_{2-c}D_{c} (0.90≤a≤1.8, 0≤b≤0.5, 0≤c≤0.05);
LiₐE_{2-b}X_{b}O_{4-c}D_{c} 0.90≤a≤1.8, 0≤b≤0.5, 0≤c≤0.05);
LiₐNi_{1-b-c}Co_{b}X_{c}D_{α}(0.90≤a≤1.8, 0≤b≤0.5, 0≤c≤0.5, 0<α≤2);
LiₐNi_{1-b-c}Co_{b}X_{c}O_{2-α}T_{α} (0.90≤a≤1.8, 0≤b≤0.5, 0≤c≤0.05, 0<α<2);
LiₐNi_{1-b-c}Co_{b}X_{c}O_{2-α}T₂ (0.90≤a≤1.8, 0≤b≤0.5, 0≤c≤0.05, 0<α<2);
LiₐNi_{1-b-c}Mn_{b}X_{c}D_{α} (0.90≤a≤1.8, 0 ≤b ≤0.5, 0≤c≤0.05, 0<α≤2);
LiₐNi_{1-b-c}Mn_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}G_{d}O₂ (0.90 ≤a ≤1.8, 0≤b≤0.9, 0≤c≤0.5, 0.001≤d≤0.1);
LiₐNi_{b}Co_{c}Mn_{d}GₑO₂ (0.90≤a ≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li _{(3-f)}J₂ (PO₄)₃ (0≤f≤2);
Li _{(3-f)}Fe₂ (PO₄)₃ (0≤f≤2);
LiₐFePO₄ (0.90≤a≤1.8).

In the above Chemical Formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, e.g., lithium cobalt oxide (LCO), lithium nickel oxide (LNO), lithium nickel cobalt oxide (LNCO), lithium nickel cobalt aluminum oxide (LNCA), lithium nickel cobalt manganese oxide (LNCM), and lithium nickel manganese oxide (LNM), lithium manganese oxide (LMO), or lithium ferrous phosphate oxide (LFP).

The positive electrode active material may include a lithium nickel oxide represented by Chemical Formula 1 below, a lithium cobalt oxide represented by Chemical Formula 2 below, a lithium ferrous phosphate compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² are each one or more elements independently selected from Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In Chemical Formula 2, 0.9≤a2≤1.8, 0.6≤x2≤1, and M³ is one or more elements selected from Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ is one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, e.g., 3 μm to 25 μm, 5 μm to 25 μm, 5 μm to 20 μm, 8 μm to 20 μm, or 10 μm to 18 μm. The positive electrode active material having the above particle diameter range can be harmoniously mixed with other components in the first positive electrode active material layer and can implement high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide Solid Electrolyte

The sulfide solid electrolyte may include, e.g., Li₂S—P₂S₅, Li₂S—P₂S₅—LiX (X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li2S—SiS2—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂—LiₚMO_{q} (p and q are integers, and M is P, Si, Ge, B, Al, Ga, or In), or combination thereof.

The sulfide solid electrolyte may be obtained by, e.g., mixing Li₂S and P₂S₅ at a molar ratio of 50:50 to 90:10 or 50:50 to 80:20 and optionally heat treating the mixture. Within the above mixing ratio range, a sulfide solid electrolyte having excellent ionic conductivity can be manufactured. Here, SiS₂, GeS₂, B₂S₃ and the like as other components may be further included to further improve the ionic conductivity.

A mechanical milling or solution method can be applied as a method of mixing sulfur-containing raw materials for producing a sulfide solid electrolyte. The mechanical milling is a method of making starting materials into particulates and mixing the same by putting the starting materials, ball mills, and the like in a reactor and intensely stirring them. In the solution method, starting materials may be mixed in a solvent to obtain a solid electrolyte as a precipitate. Furthermore, if heat treatment is performed after mixing, crystals of the solid electrolyte can become more rigid and ionic conductivity can be improved. As an example, the sulfide solid electrolyte can be manufactured by mixing sulfur-containing raw materials and heat-treating them two or more times. In this case, a sulfide solid electrolyte with high ionic conductivity and rigidity can be manufactured.

As an example, the sulfide solid electrolyte particles may include argyrodite-type sulfide. For example, the argyrodite-type sulfide can be represented by the Chemical Formula of LiₐM_{b}P_{c}S_{d}Aₑ (a, b, c, d, and e are all 0 or greater and 12 or less, M is Ge, Sn, Si, or a combination thereof, and A is F, Cl, Br, or I), e.g., the Chemical Formula of Li₇₋ₓPS₆₋ₓAₓ (x is 0.2 or greater and 1.8 or less, and A is F, Cl, Br, or I). For example, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8} or the like.

A sulfide solid electrolyte particle containing such argyrodite-type sulfide has high ionic conductivity close to about 10⁻⁴ to about 10⁻² S/cm, which is ionic conductivity of a general liquid electrolyte, at room temperature, and thus, can form a close bond between the positive electrode active material and the solid electrolyte, and further, a close interface between the electrode layer and the solid electrolyte layer without deteriorating the ionic conductivity. An all-solid-state battery including the same may exhibit improved battery performance such as rate characteristics, coulombic efficiency, and life characteristics.

The argyrodite-type sulfide solid electrolyte can be manufactured by, e.g., mixing lithium sulfide, phosphorus sulfide, and optionally lithium halide. After mixing them, heat treatment may be performed. The heat treatment may include, e.g., two or more heat treatment steps.

An average particle diameter (D50) of the sulfide solid electrolyte particle according to an embodiment may be 5.0 μm or less, e.g., 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide solid electrolyte particle may be a small particle having an average particle diameter (D50) of 0.1 μm to 1.0 μm or a large particle having an average particle diameter (D50) of 1.5 μm to 5.0 μm, depending on the location or purpose of use. The sulfide solid electrolyte particle in the particle diameter range can effectively penetrate between solid particles in the battery, and has an excellent contact property with the electrode active material and connectivity between the solid electrolyte particles. The average particle diameter of the sulfide solid electrolyte particle may be measured using a microscope image. For example, a particle size distribution may be obtained by measuring sizes of about 20 particles in a scanning electron microscope image, and D50 may be calculated from the particle size distribution.

The content of the solid electrolyte in the positive electrode for an all-solid-state battery may be 0.5 wt % to 35 wt %, e.g., 1 wt % to 35 wt %, 5 wt % to 30 wt %, 8 wt % to 25 wt %, or 10 wt % to 20 wt %, with respect to a total weight of components in the positive electrode, e.g., may be a content with respect to a total weight of the first positive electrode active material layer.

In an embodiment, the first positive electrode active material layer may include 50 wt % to 99.35 wt % of the positive electrode active material, 0.5 wt % to 35 wt % of the sulfide solid electrolyte, 0.1 wt % to 10 wt % of the fluorine resin binder, and 0.05 wt % to 5 wt % of the vanadium oxide, with respect to 100 wt % of the first positive electrode active material layer. When such a content range is satisfied, the positive electrode for an all-solid-state secondary battery maintains high adhesive force and also maintains the viscosity of the positive electrode composition at an appropriate level while implementing high capacity and high ionic conductivity, thereby improving processability.

### Conductive Material

The first positive electrode active material layer may further include a conductive material. The conductive material is used to provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt %, with respect to a total weight of components of the positive electrode for an all-solid-state battery, or with respect to the total weight of the first positive electrode active material layer. Within the above content range, the conductive material can improve electrical conductivity without deteriorating battery performance.

If the first positive electrode active material layer further includes a conductive material, the first positive electrode active material layer may include 45 wt % to 99.25 wt % of the positive electrode active material, 0.5 wt % to 35 wt % of the sulfide solid electrolyte, 0.1 wt % to 10 wt % of the fluorine resin binder, 0.05 wt % to 5 wt % of the vanadium oxide, and 0.1 wt % to 5 wt % of the conductive material, with respect to 100 wt % of the first positive electrode active material layer.

Note that the positive electrode for a lithium secondary battery may further include an oxide inorganic solid electrolyte, in addition to the solid electrolyte described above. The oxide inorganic solid electrolyte may include, e.g., Li₁₊ₓTi₂₋ₓAl (PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} (PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M is Te, Nb, or Zr; x is an integer from 1 to 10), or combination thereof.

### All-Solid-State Secondary Battery

An embodiment provides an all-solid-state secondary battery including the positive electrode described above, a negative electrode, and a solid electrolyte layer positioned between the positive electrode and the negative electrode. The all-solid-state secondary battery may be expressed as an all-solid-state battery or an all-solid-state lithium secondary battery.

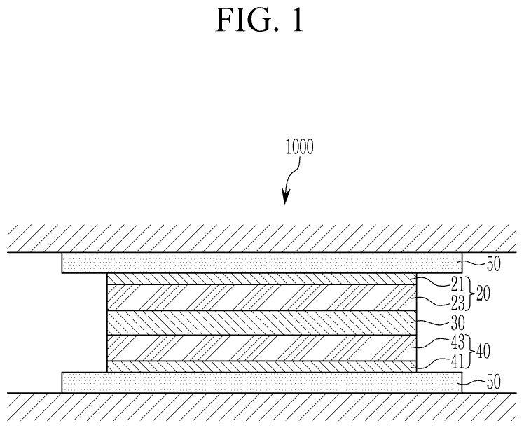

FIG. 1 is a cross-sectional view of an all-solid-state battery, according to embodiments.

Referring to FIG. 1, an all-solid-state battery 1000 may include an electrode assembly, in which a negative electrode 40 including a negative electrode current collector 41 and a negative electrode active material layer 43, a solid electrolyte layer 30, and a positive electrode 20 including a positive electrode active material layer 23 and a positive electrode current collector 21 are stacked, in a case, e.g., a pouch. The all-solid-state battery 1000 may further include an elastic layer 50 on an outer side of at least one of the positive electrode 20 and the negative electrode 40. For example, as illustrated in FIG. 1, the all-solid-state battery 1000 may include one electrode assembly including the negative electrode 40, the solid electrolyte layer 30, and the positive electrode 20. In another example, an all-solid-state battery may be manufactured by stacking two or more electrode assemblies.

### Negative Electrode

The negative electrode for an all-solid-state battery may include, e.g., a current collector and a negative electrode active material layer positioned on the current collector. The negative electrode active material layer may include a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions is a carbon negative electrode active material, and may include, e.g., crystalline carbon, amorphous carbon, or a combination thereof. Examples of the crystalline carbon may include graphite, e.g., amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used.

For the material capable of being doped or undoped on the lithium, a Si negative electrode active material or an Sn negative electrode active material may be used. Examples of the Si negative electrode active material may include silicon, silicon-carbon composite, SiOₓ (0<x<2), and a Si-Q alloy (Q is an element selected from alkali metals, alkali earth metals, Group 13 elements, Group 14 elements, Group 15 elements, Group 16 elements, transition metals, rare-earth elements, and combinations thereof, but is not Si). Examples of the Sn negative electrode active material may include Sn, SnO₂, a Sn—R alloy (R is an element selected from alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected and used from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, e.g., a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal pitch, mesophase pitch, petroleum pitch, coal oil, petroleum heavy oil, or polymer resin such as phenol resin, furan resin, and polyimide resin can be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D50) of the silicon particle may be 10 nm to 20 μm, e.g., 10 nm to 500 nm. The silicon particle may be present in an oxidized form, and in this case, an atomic content ratio of Si: O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D50) is measured with a particle size analyzer using a laser diffraction method and refers to a diameter of a particle with a cumulative volume of 50% by volume in the particle size distribution.

The Si negative electrode active material or Sn negative electrode active material may be used by mixing with a carbon negative electrode active material. A mixing ratio of the Si negative electrode active material or Sn negative electrode active material and the carbon negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer may further include a binder, and optionally, may further include a conductive material. A content of the binder in the negative electrode active material layer may be 1 wt % to 5 wt % with respect to the total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

If a water-soluble binder is used as the negative electrode binder, a thickener capable of imparting viscosity may be used together, and the thickener may include, e.g., a cellulose compound. The cellulose compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state battery may be a precipitation-type negative electrode. The precipitation-type negative electrode refers to a negative electrode which does not include a negative electrode active material during assembly of a battery but in which lithium metal or the like is precipitated during charging of the battery and serves as a negative electrode active material.

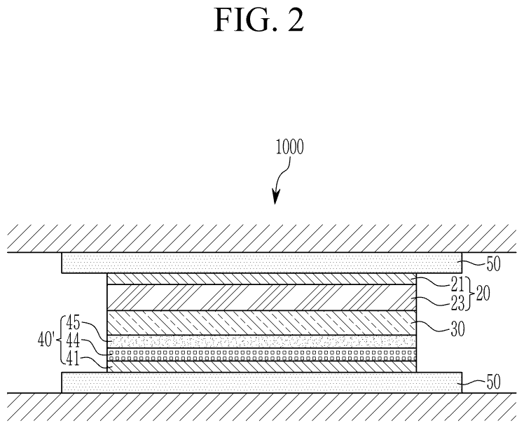

FIG. 2 is a cross-sectional view of an all-solid-state battery including a precipitation-type negative electrode.

Referring to FIG. 2, the precipitation-type negative electrode 40′ may include a current collector 41 and a negative electrode coating layer 45 positioned on the current collector. In an all-solid-state battery having the precipitation-type negative electrode 40′, initial charging begins in the absence of a negative electrode active material, and during the charging, lithium metal with a high density or the like is precipitated between the current collector 41 and the negative electrode coating layer 45 and forms a lithium metal layer 44, which can serve as a negative electrode active material. Accordingly, in an all-solid-state battery that has been charged once or more, the precipitation-type negative electrode 40′ may include the current collector 41, the lithium metal layer 44 positioned on the current collector, and the negative electrode coating layer 45 positioned on the metal layer. The lithium metal layer 44 refers to a layer of lithium metal or the like precipitated during the charging process of the battery and may be called a metal layer or a negative electrode active material layer.

The negative electrode coating layer 45 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more than one thereof. If the metal is present in the form of a particle, an average particle diameter (D50) thereof may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, a mesophase carbon microbead, or a combination thereof. The amorphous carbon may be, e.g., carbon black, activated carbon, acetylene black, Denka black, Ketjen black, or a combination thereof.

If the negative electrode coating layer 45 includes both the metal and the carbon material, a mixing ratio of the metal and the carbon material may be, e.g., 1:10 to 2:1 at a weight ratio. In this case, the precipitation of lithium metal can be effectively promoted and the characteristics of the all-solid-state battery can be improved. The negative electrode coating layer 45 may include, e.g., a carbon material on which catalyst metal is supported, or a mixture of metal particles and carbon material particles.

The negative electrode coating layer 45 may include, e.g., the metal and amorphous carbon, and in this case, the precipitation of lithium metal can be effectively promoted.

The negative electrode coating layer 45 may further include a binder, and the binder may be a conductive binder. Furthermore, the negative electrode coating layer 45 may further include general additives, e.g., a filler, a dispersant, and an ion conductive material.

A thickness of the negative electrode coating layer 45 may be, e.g., 100 nm to 20 μm, 500 nm to 10 μm, or 1 μm to 5 μm.

For example, the precipitation-type negative electrode 40′ may further include a thin film on the surface of the current collector, i.e., between the current collector and the negative electrode coating layer. The thin film may contain an element that can form an alloy with lithium. The element that can form an alloy with lithium may be, for example, gold, silver, zinc, tin, indium, silicon, aluminum, bismuth, and the like, which may be used alone or as an alloy of more than one thereof. The thin film can further planarize a precipitation shape of the lithium metal layer 44 and further improve the characteristics of the all-solid-state battery. The thin film may be formed by, e.g., a vacuum deposition method, a sputtering method, a plating method, or the like. The thin film may have a thickness of, e.g., 1 nm to 500 nm.

### Solid Electrolyte Layer

The solid electrolyte layer 30 may include a sulfide solid electrolyte, an oxide solid electrolyte, and the like. The detailed descriptions of the sulfide solid electrolyte and the oxide solid electrolyte are the same as above.

In one example, the solid electrolyte included in the positive electrode 20 and the solid electrolyte included in the solid electrolyte layer 30 may include the same compound or different compounds. For example, if both the positive electrode 20 and the solid electrolyte layer 30 include an argyrodite-type sulfide solid electrolyte, the overall performance of the all-solid-state secondary battery can be improved. In another example, if both the positive electrode 20 and the solid electrolyte layer 30 include the coated solid electrolyte described above, the all-solid-state secondary battery can implement excellent initial efficiency and life characteristics while implementing a high capacity and a high energy density.

Note that the average particle diameter (D50) of the solid electrolyte included in the positive electrode 20 may be smaller than the average particle diameter (D50) of the solid electrolyte included in the solid electrolyte layer 30. In this case, the overall performance can be improved by maximizing the energy density of the all-solid-state battery and increasing the mobility of lithium ions. For example, the average particle diameter (D50) of the solid electrolyte included in the positive electrode 20 may be 0.1 μm to 1.0 μm, or 0.1 μm to 0.8 μm, and the average particle diameter (D50) of the solid electrolyte included in the solid electrolyte layer 30 may be 1.5 μm to 5.0 μm, 2.0 μm to 4.0 μm, or 2.5 μm to 3.5 μm. If the above particle diameter ranges are satisfied, the energy density of the all-solid-state secondary battery is maximized and the transfer of lithium ions is facilitated, making it possible to suppress resistance and thus to improve the overall performance of the all-solid-state secondary battery. Here, the average particle diameter (D50) of the solid electrolyte may be measured with a particle size analyzer using a laser diffraction method. Alternatively, a particle size distribution may be obtained by measuring sizes of about 20 particles selected from a microscope image such as a scanning electron microscope, and a D50 value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate polymer, or a combination thereof may be used, but the present disclosure is not limited thereto, and any binder used in the art can be used. The acrylate polymer may be, e.g., butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, e.g., 10 μm to 150 μm.

The solid electrolyte layer may further include an alkali metal salt, and/or an ionic liquid, and/or a conductive polymer.

The alkali metal salt may be, e.g., a lithium salt. A content of the lithium salt in the solid electrolyte layer may be 1 M or more, e.g., 1 M to 4 M. In this case, the lithium salt can improve ionic conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

Furthermore, the lithium salt may be an imide salt. For example, the imide lithium salt may include lithium bis(trifluoro methanesulfonyl)imide, LiTFSI, LiN(SO₂CF₃)₂), lithium bis(fluorosulfonyl)imide, LiFSI, LiN(SO₂F)₂). The lithium salt can maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium, pyrrolidinium, pyridinium, pyrimidinium, imidazolium, piperidinium, pyrazolium, oxazolium, pyridazinium, phosphonium, sulfonium, and triazolium cations and a mixture thereof, and b) one or more anions selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)2N—, (C₂F₅SO₂, CF₃SO₂)N—, and (CF₃SO₂)₂N—.

The ionic liquid may be, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. The solid electrolyte layer that satisfies the above ranges can maintain or improve ionic conductivity by improving the electrochemical contact area with the electrode. Accordingly, the energy density, discharge capacity, rate characteristics, and the like of the all-solid-state battery can be improved.

The all-solid-state battery may include a unit cell having a structure of a positive electrode/a solid electrolyte layer/a negative electrode, a bi-cell structure having a structure of a positive electrode/a solid electrolyte layer/a negative electrode/a solid electrolyte layer/a positive electrode, or a bipolar cell structure in which unit cells are repeatedly stacked.

A shape of the all-solid-state battery may be, e.g., a coin shape, a button shape, a sheet shape, a stack shape, a cylindrical shape, a flat shape, or the like. In addition, the all-solid-state battery can also be applied to large-sized batteries used in electric vehicles, and the like. For example, the all-solid-state battery can also be used in a hybrid vehicle such as a plug-in hybrid electric vehicle (PHEV). Furthermore, it can be used in fields that require a large amount of power storage, e.g., can also be used to an electric bicycle, an electric tool or the like.

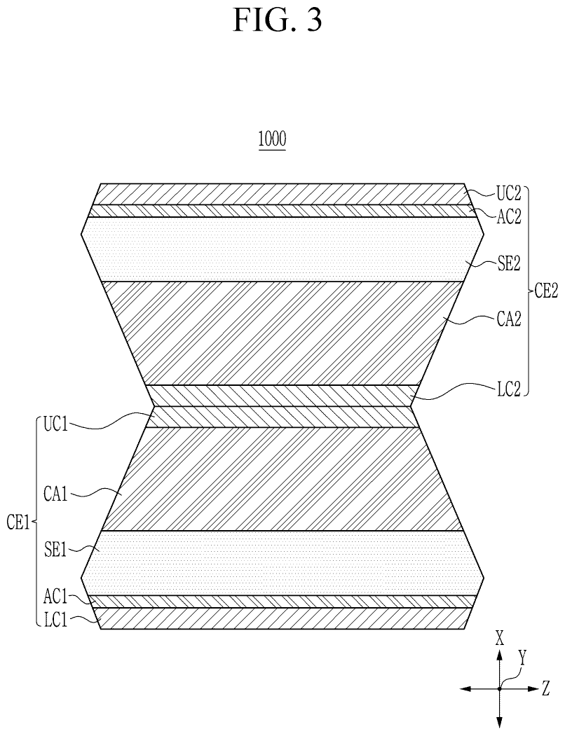

Below, an all-solid-state secondary battery according to an embodiment will be described with reference to FIGS. 3 to 9. The all-solid-state secondary battery 1000 according to an embodiment is a secondary battery capable of charging and discharging. Hereinafter, the positive electrode includes a cathode, and the negative electrode includes an anode.

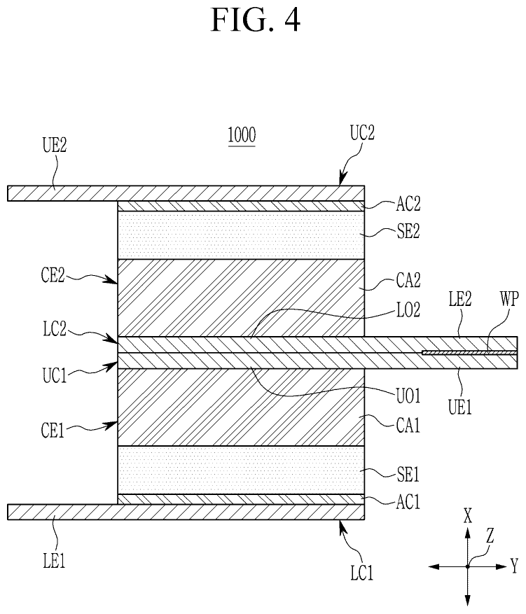

FIG. 3 is a longitudinal cross-sectional view showing the front of an all-solid-state secondary battery according to an embodiment. FIG. 3 is a longitudinal cross-sectional view showing the all-solid-state secondary battery in a second direction (Y) intersecting with a first direction (X) shown in FIG. 3. FIG. 4 is a longitudinal cross-sectional view showing a side of the all-solid-state secondary battery according to the embodiment. FIG. 4 is a longitudinal cross-sectional view showing the all-solid-state secondary battery in a third direction (Z) intersecting with the first direction (X) and the second direction (Y) shown in FIG. 4.

Referring to FIGS. 3 and 4, the all-solid-state secondary battery 1000 according to an embodiment may include a first unit cell CE1 and a second unit cell CE2 stacked in the first direction (X) to form a bi-cell structure. For example, as illustrated in FIG. 3, sides of each of the first and second unit cells CE1 and CE2 may be slopes, as viewed in the XZ plane.

The first unit cell CE1 may include a first lower current-collecting layer LC1, a first negative electrode coating layer AC1, a first solid electrolyte layer SE1, a first positive electrode active material layer CA1, and a first upper current-collecting layer UC1 sequentially stacked in the first direction (X). For example, as illustrated in FIG. 3, a length of each of the layers of the first unit cell CE1 in the third direction (Z) may be non-constant (e.g., may have a trapezoidal cross-section in the XZ plane).

The first lower current-collecting layer LC1 may be a negative electrode current-collecting layer. The first lower current-collecting layer LC1 may face the first solid electrolyte layer SE1 with the first negative electrode coating layer AC1 interposed therebetween. The first lower current-collecting layer LC1 may include any suitable metal and/or compound that do not react with lithium. For example, the first lower current-collecting layer LC1 may include stainless steel (SUS) and the like, and may have a plate shape or a foil shape. For example, the first lower current-collecting layer LC1 may include at least one of copper (Cu), stainless steel (SUS), titanium (Ti), iron (Fe), cobalt (Co), and nickel (Ni). An area (e.g., a length in the second direction (Y)) of the first lower current-collecting layer LC1 may be greater than those of the first positive electrode active material layer CA1 and the first upper current-collecting layer UC1, as illustrated in FIG. 4. The first lower current-collecting layer LC1 may include a first lower extension portion LE1 extending in the second direction (Y) intersecting with the first direction (X), and the first lower extension portion LE1 may be connected to (e.g., and may overlap in the first direction (X)) a second upper extension portion UE2 of the second upper current-collecting layer UC2 of the second unit cell CE2 through any suitable connecting member.

The first negative electrode coating layer AC1 may be positioned between the first lower current-collecting layer LC1 and the first solid electrolyte layer SE1. The first negative electrode coating layer AC1 may be in contact (e.g., direct contact) with the first lower current-collecting layer LC1 and the first solid electrolyte layer SE1. For example, the first negative electrode coating layer AC1 may include silver (Ag) and carbon (C). For example, the first negative electrode coating layer AC1 may include particles formed of metal or semiconductor including at least one of gold (Au), platinum (Pt), palladium (Pd), silicon (Si), silver (Ag), aluminum (Al), bismuth (Bi), tin (Sn), and zine (Zn) in a carbon layer including at least one of carbon black, furnace black (FB), acetylene black (AB), Ketjen black (KB), and graphene. During charging, lithium is precipitated between the first lower current-collecting layer LC1 and the first negative electrode coating layer AC1, forming a lithium metal layer between the first lower current-collecting layer LC1 and the first negative electrode coating layer AC1. After discharging, lithium is not precipitated between the first lower current-collecting layer LC1 and the first negative electrode coating layer AC1, so that the first lower current-collecting layer LC1 and the first negative electrode coating layer AC1 may be in direct contact with each other. An area of an interface between the first negative electrode coating layer AC1 and the first lower current-collecting layer LC1 (e.g., in the YZ plane) may be greater than an area of the first upper current-collecting layer UC1 (e.g., an area of a surface of the first upper current-collecting layer UC1 facing the first positive electrode active material layer CA1).

The first solid electrolyte layer SE1 may be positioned between the first positive electrode active material layer CA1 and the first negative electrode coating layer AC1. The first solid electrolyte layer SE1 may be in direct contact with the first positive electrode active material layer CA1 and the first negative electrode coating layer AC1. For example, the first solid electrolyte layer SE1 may include Li₂S—P₂S₅, Li₂S—P₂S₅—LiX (X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is one of Ge, Zn or Ga), Li₂S—GeS₂, Li₂S—SiS₂—Li₃PO₄, Li₂S—SiS₂—LiₚMO_{q} (p and q are positive numbers, and M is one of P, Si, Ge, B, Al, Ga and In), etc. The first solid electrolyte layer SE1 may include at least one of amorphous and crystalline materials.

The first positive electrode active material layer CA1 is positioned between the first solid electrolyte layer SE1 and the first upper current-collecting layer UC1. For example, the first positive electrode active material layer CA1 may be coated on the first upper current-collecting layer UC1. The first positive electrode active material layer CA1 may include lithium nickel cobalt manganate (NCM). As an example, the first positive electrode active material layer CA1 may include at least one of a lithium salt such as lithium cobalt oxide (LCO), lithium nickel oxide, lithium nickel cobalt oxide, lithium nickel cobalt aluminum oxide (NCA), lithium nickel cobalt manganate (NCM), lithium manganate, and lithium iron phosphate, nickel sulfide, copper sulfide, lithium sulfide, sulfur, iron oxide, or vanadium oxide. An area (e.g., a maximal length in the third direction (Z)) of the first positive electrode active material layer CA1 may be greater than that of the first upper current-collecting layer UC1, and may be smaller than the area (e.g., a length in the third direction (Z)) of the interface between the first lower current-collecting layer LC1 and the first negative electrode coating layer AC1. Here, the area of the first positive electrode active material layer CA1 refers to an area of a lower surface of the first positive electrode active material layer CA1 (e.g., a surface of the first positive electrode active material layer CA1 facing and contacting the first solid electrolyte layer SE1). For example, the first positive electrode active material layer CA1 may form (e.g., define) a positive electrode (cathode) together with the first upper current-collecting layer UC1.

The first upper current-collecting layer UC1 may be a positive electrode current-collecting layer. The first upper current-collecting layer UC1 may include aluminum (Al) and may have a plate shape or a foil shape. As an example, the first upper current-collecting layer UC1 may include at least one of indium (In), copper (Cu), magnesium (Mg), stainless steel (SUS), titanium (Ti), iron (Fe), cobalt (Co), nickel (Ni), zinc (Zn), aluminum (Al), germanium (Ge), and lithium (Li). The area of the first upper current-collecting layer UC1 (e.g., an area of a surface of the first upper current-collecting layer UC1 facing the first positive electrode active material layer CA1) may be smaller than the area of the first positive electrode active material layer CA1 (e.g., an area of the surface of the first positive electrode active material layer CA1 facing and contacting the first solid electrolyte layer SE1) and smaller than the area of the interface between the first lower current-collecting layer LC1 and the first negative electrode coating layer AC1.

The first upper current-collecting layer UC1 may include a first upper extension portion UE1 and a first upper overlapping portion UO1 (FIG. 4).

The first upper extension portion UE1 may extend in the second direction (Y) intersecting with the first direction (X). The first upper extension portion UE1 may be welded to a second lower extension portion LE2 of the second lower current-collecting layer LC2 of the second unit cell CE2. The first upper extension portion UE1 may be welded to the second lower extension portion LE2 of the second lower current-collecting layer LC2 by a weld portion WP. The first upper extension portion UE1 may not overlap the first solid electrolyte layer SE1 and the second solid electrolyte layer SE2 of the second unit cell CE2 in the first direction (X). The first upper extension portion UE1 may extend in an opposite direction to the first lower extension portion LE1 with respect to the second direction (Y).

The first upper overlapping portion UO1 may extend from the first upper extension portion UE1 into a space between the first solid electrolyte layer SE1 and the second solid electrolyte layer SE2 of the second unit cell CE2. The first upper overlapping portion UO1 may be positioned between the first solid electrolyte layer SE1 and the second solid electrolyte layer SE2. The first upper overlapping portion UO1 may be positioned between the first positive electrode active material layer CA1 and the second lower current-collecting layer LC2 of the second unit cell CE2 in the first direction (X) and may overlap the second lower overlapping portion LO2 of the second lower current-collecting layer LC2 in the first direction (X). The first upper overlapping portion UO1 may be in contact with the second lower overlapping portion LO2 of the second lower current-collecting layer LC2. The first upper overlapping portion UO1 may not be welded to the second lower overlapping portion LO2, and the first upper extension portion UE1 may be welded to the second lower extending portion LE2 by the weld portion WP. Welding between the first upper extension portion UE1 and the second lower extension portion LE2 may be performed, e.g., using, a laser beam irradiated in a direction that the extension portions do not overlap the first solid electrolyte layer SE1 and the second solid electrolyte layer SE2 in the first direction (X).

As illustrated in FIG. 3, the front of the above-described first unit cell CE1 may have a substantial diamond shape due to inclined surfaces. The second unit cell CE2 may be stacked on the first unit cell CE1, and the second unit cell CE2 may have such a shape that is rotated 180 degrees about the second direction (Y) with respect to the first unit cell CE1 (e.g., the first and second unit cells CE1 and CE2 may symmetrical (e.g., mirror images of each other) about the second direction (Y) and the third direction (Z)).

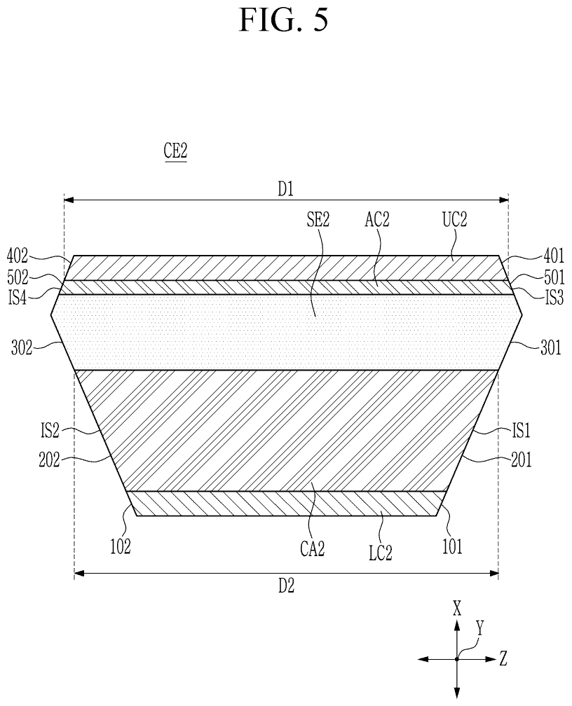

FIG. 5 is a longitudinal cross-sectional view showing the second unit cell CE2 of the all-solid-state secondary battery according to the embodiment.

Referring to FIGS. 3 to 5, the second unit cell CE2 may be positioned on the first upper current-collecting layer UC1 of the first unit cell CE1. The second unit cell CE2 may include a second lower current-collecting layer LC2, a second positive electrode active material layer CA2, a second solid electrolyte layer SE2, a second negative electrode coating layer AC2, and a second upper current-collecting layer UC2, which are sequentially stacked on top of each other in the first direction (X). As illustrated in FIG. 5, the second unit cell CE2 may further include a first inclined surface IS1, a second inclined surface IS2, a third inclined surface IS3, and a fourth inclined surface IS4. The first unit cell CE1 may also include the same inclined surfaces as the first inclined surface IS1, the second inclined surface IS2, the third inclined surface IS3, and the fourth inclined surface IS4 of the second unit cell CE2.

The second lower current-collecting layer LC2 may be a positive electrode current-collecting layer. The second lower current-collecting layer LC2 may include aluminum (Al) and may have a plate shape or a foil shape. As an example, the second lower current-collecting layer LC2 may include at least one of indium (In), copper (Cu), magnesium (Mg), stainless steel (SUS), titanium (Ti), iron (Fe), cobalt (Co), nickel (Ni), zinc (Zn), aluminum (Al), germanium (Ge), and lithium (Li). An area of the second lower current-collecting layer LC2 may be smaller than a second area (e.g., a surface area including a second length D2) of the second positive electrode active material layer CA2 and a first area (e.g., a surface area including a first length D1) of an interface between the second upper current-collecting layer UC2 and the second negative electrode coating layer AC2.

The second lower current-collecting layer LC2 may include the second lower extension portion LE2 and the second lower overlapping portion LO2 (FIG. 4).

The second lower extension portion LE2 may extend in the second direction (Y) intersecting with the first direction (X). The second lower extension portion LE2 may be welded to the first upper extension portion UE1 of the first upper current-collecting layer UC1 of the first unit cell CE1. The second lower extension portion LE2 may be welded to the first upper extension portion UE1 of the first upper current-collecting layer UC1 by the weld portion WP. The second lower extension portion LE2 may not overlap the second solid electrolyte layer SE2 and the first solid electrolyte layer SE1 of the first unit cell CE1 in the first direction (X). The second lower extension portion LE2 may extend in the same direction as the first upper extension portion UE1 with respect to the second direction (Y), and the second lower extension portion LE2 may extend in an opposite direction to the second upper extension portion UE2 with respect to the second direction (Y).

The second lower overlapping portion LO2 may extend from the second lower extension portion LE2 into the space between the second solid electrolyte layer SE2 and the first solid electrolyte layer SE1 of the first unit cell CE1. The second lower overlapping portion LO2 may be positioned between the second solid electrolyte layer SE2 and the first solid electrolyte layer SE1. The second lower overlapping portion LO2 may be positioned between the second positive electrode active material layer CA2 and the first upper current-collecting layer UC1 of the first unit cell CE1 in the first direction (X) and may overlap the first upper overlapping portion UO1 of the first upper current-collecting layer UC1 in the first direction (X). The second lower overlapping portion LO2 may be in contact (e.g., direct contact) with the first upper overlapping portion UO1 of the first upper current-collecting layer UC1. The second lower overlapping portion LO2 may not be welded to the first upper overlapping portion UO1, and the second lower extension portion LE2 may be welded to the first upper extending portion UE1 by the weld portion WP.

The second positive electrode active material layer CA2 may be positioned between the second solid electrolyte layer SE2 and the second lower current-collecting layer LC2. The second positive electrode active material layer CA2 may be coated on the second lower current-collecting layer LC2. The second positive electrode active material layer CA2 may include lithium nickel cobalt manganate (NCM). As an example, the second positive electrode active material layer CA2 may include at least one of a lithium salt, e.g., lithium cobalt oxide (LCO), lithium nickel oxide, lithium nickel cobalt oxide, lithium nickel cobalt aluminum oxide (NCA), lithium nickel cobalt manganate (NCM), lithium manganate, and lithium iron phosphate, nickel sulfide, copper sulfide, lithium sulfide, sulfur, iron oxide, or vanadium oxide. The second area (i.e., including the second length D2) of the second positive electrode active material layer CA2 may be greater than the area of the second lower current-collecting layer LC2 and smaller than the first area (i.e., including the first length D1) of the interface between the second upper current-collecting layer UC2 and the second negative electrode coating layer AC2. Here, the area of the second positive electrode active material layer CA2 refers to an area of an upper surface (i.e., a surface including the second length D2) of the second positive electrode active material layer CA2. For example, the second positive electrode active material layer CA2 may form a positive electrode (cathode) together with the second lower current-collecting layer LC2.

The second solid electrolyte layer SE2 may be positioned between the second positive electrode active material layer CA2 and the second negative electrode coating layer AC2. The second solid electrolyte layer SE2 may be in direct contact with the second positive electrode active material layer CA2 and the second negative electrode coating layer AC2. The second solid electrolyte layer SE2 may include, e.g., any suitable sulfide solid electrolyte materials. As an example, the second solid electrolyte layer SE2 may include Li₂S—P₂S₅, Li2S—P₂S₅—LiX (X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is one of Ge, Zn or Ga), Li₂S—GeS₂, Li₂S—SiS₂—Li₃PO₄, Li2S—SiS2—LiₚMO_{q} (p and q are positive numbers, and M is one of P, Si, Ge, B, Al, Ga and In), etc. The second solid electrolyte layer SE2 may include at least one of amorphous and crystalline materials.

The second negative electrode coating layer AC2 may be positioned between the second upper current-collecting layer UC2 and the second solid electrolyte layer SE2. The second negative electrode coating layer AC2 may be in contact (e.g., direct contact) with the second upper current-collecting layer UC2 and the second solid electrolyte layer SE2. The second negative electrode coating layer AC2 may include, e.g., silver (Ag) and carbon (C). As an example, the second negative electrode coating layer AC2 may include particles formed of metal or semiconductor including at least one of, e.g., gold (Au), platinum (Pt), palladium (Pd), silicon (Si), silver (Ag), aluminum (Al), bismuth (Bi), tin (Sn), and zinc (Zn) in a carbon layer including at least one of, e.g., carbon black, furnace black (FB), acetylene black (AB), Ketjen black (KB), and graphene. During charging, lithium is precipitated between the second upper current-collecting layer UC2 and the second negative electrode coating layer AC2, forming a lithium metal layer between the second upper current-collecting layer UC2 and the second negative electrode coating layer AC2. After discharging, lithium is not precipitated between the second upper current-collecting layer UC2 and the second negative electrode coating layer AC2, so that the second upper current-collecting layer UC2 and the second negative electrode coating layer AC2 may be in direct contact with each other. The first area (i.e., including the first length D1) of the interface between the second negative electrode coating layer AC2 and the second upper current-collecting layer UC2 may be greater than an area of the second lower current-collecting layer LC2. The first inclined surface IS1, the second inclined surface IS2, the third inclined surface IS3, and the fourth inclined surface IS4 make the first area (i.e., that includes the first length D1) of the interface between the second negative electrode coating layer AC2 and the second upper current-collecting layer UC2 greater than the second area (i.e., that includes the second length D2) of the second positive electrode active material layer CA2.

The second upper current-collecting layer UC2 may be a negative electrode current-collecting layer. The second upper current-collecting layer UC2 faces the second solid electrolyte layer SE2 with the second negative electrode coating layer AC2 interposed therebetween. The second upper current-collecting layer UC2 may include any suitable metals and compounds that do not react with lithium. The second upper current-collecting layer UC2 may include stainless steel (SUS) and the like, and may have a plate shape or a foil shape. As an example, the second upper current-collecting layer UC2 may include at least one of copper (Cu), stainless steel (SUS), titanium (Ti), iron (Fe), cobalt (Co), and nickel (Ni). An area of the second upper current-collecting layer UC2 may be greater than the second area (i.e., that includes the second length D2) of the second positive electrode active material layer CA2 and the area of the second lower current-collecting layer LC2. The second upper current-collecting layer UC2 may include a second upper extension portion UE2 extending in the second direction (Y) intersecting with the first direction (X), and the second upper extension portion UE2 may be connected to the first lower extension portion LE1 of the first lower current-collecting layer LC1 of the first unit cell CE1 through, e.g., any suitable connecting members. The second upper extension portion UE2 may extend in the same direction as the first lower extension portion LE1 with respect to the second direction (Y), and the second upper extension portion UE2 may extend in an opposite direction to the second lower extension portion LE2 and the first upper extension portion UE1 with respect to the second direction (Y).

The second upper current-collecting layer UC2 and the first lower current-collecting layer LC1 may have negative electrodes of the same first polarity, and the second lower current-collecting layer LC2 and the first upper current-collecting layer UC1 connected to each other may have positive electrodes of the same second polarity. As an example, the first unit cell CE1 and the second unit cell CE2 may form a bi-cell structure.

The first inclined surface IS1 may extend from one end portion 101, in the third direction (Z), of the second lower current-collecting layer LC2 to one end portion 301, in the third direction (Z), of the second solid electrolyte layer SE2 via one end portion 201, in the third direction (Z), of the second positive electrode active material layer CA2. The first inclined surface IS1 may be wider than the third inclined surface IS3 and longer than the third inclined surface IS3. The first inclined surface IS1 may be in contact with the third inclined surface IS3 at one end portion 301 of the second solid electrolyte layer SE2. For example, referring to FIG. 5, an end portion may refer to a lateral surface connecting upper and lower surfaces of a layer.

The second inclined surface IS2 may extend from the other end portion 102, in the third direction (Z), of the second lower current-collecting layer LC2 to the other end portion 302, in the third direction (Z), of the second solid electrolyte layer SE2 via the other end portion 202, in the third direction (Z), of the second positive electrode active material layer CA2. The second inclined surface IS2 may be wider than the fourth inclined surface IS4 and longer than the fourth inclined surface IS4. The second inclined surface IS2 may be in contact with the fourth inclined surface IS4 at the other end portion 302 of the second solid electrolyte layer SE2.

The third inclined surface IS3 may extend from one end portion 401, in the third direction (Z), of the second upper current-collecting layer UC2 to one end portion 301, in the third direction (Z), of the second solid electrolyte layer SE2 via one end portion 501, in the third direction (Z), of the second negative electrode coating layer AC2. The third inclined surface IS3 may be narrower than the first inclined surface IS1 and shorter than the first inclined surface IS1.

The fourth inclined surface IS4 may extend from the other end portion 402, in the third direction (Z), of the second upper current-collecting layer UC2 to the other end portion 302, in the third direction (Z), of the second solid electrolyte layer SE2 via the other end portion 502 of the second negative electrode coating layer AC2. The fourth inclined surface IS4 may be narrower than the second inclined surface IS2 and shorter than the second inclined surface IS2.

For example, the first inclined surface IS1, the second inclined surface IS2, the third inclined surface IS3, and the fourth inclined surface IS4 may be formed by cutting both upper and lower end portions of the second unit cell CE2 into a tapered shape via any suitable method and/or device, e.g., a laser beam. The second unit cell CE2 may be formed in a substantial diamond shape by the first inclined surface IS1, the second inclined surface IS2, the third inclined surface IS3, and the fourth inclined surface IS4. The second unit cell CE2 may be defined as a diamond shape by the first inclined surface IS1, the second inclined surface IS2, the third inclined surface IS3, and the fourth inclined surface IS4, so that the first area (that includes the first side D1) of the interface between the second negative electrode coating layer AC2 and the second upper current-collecting layer UC2, in which lithium is precipitated to form a lithium metal layer during charging, may be greater than the second area (that includes the second side D2) of the second positive electrode active material layer CA2.

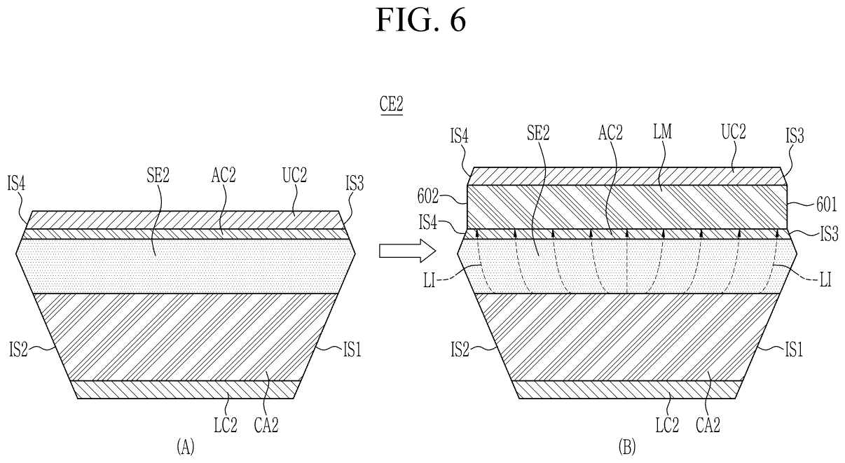

FIG. 6 illustrates longitudinal cross-sectional views showing formation of a lithium metal layer in the second unit cell CE2 of the all-solid-state secondary battery according to the embodiment. Part (A) of FIG. 6 is a longitudinal cross-sectional view showing the second unit cell after discharging, and part (B) of FIG. 6 is a longitudinal cross-sectional view showing the second unit cell CE2 after charging.

Referring to parts (A) and (B) of FIG. 6, during charging, lithium ions LI migrate from the second positive electrode active material layer CA2 to the interface between the second negative electrode coating layer AC2 and the second upper current-collecting layer UC2 via the second solid electrolyte layer SE2 and are precipitated in the interface between the second negative electrode coating layer AC2 and the second upper current-collecting layer UC2. As a result, a lithium metal layer LM is formed in the interface between the second negative electrode coating layer AC2 and the second upper current-collecting layer UC2 during charging. An area of the lithium metal layer LM (e.g., an area of a surface of the lithium metal layer LM facing the second negative electrode coating layer AC2) may be greater than the area of the second positive electrode active material layer CA2 and the area of the second lower current-collecting layer LC2. One end portion 601 of the lithium metal layer LM may divide the third inclined surface IS3, and the other end portion 602 of the lithium metal layer LM may divide the fourth inclined surface IS4. The lithium metal layer LM may form a negative electrode (anode) together with the second upper current-collecting layer UC2 and the second negative electrode coating layer AC2.

Referring to FIGS. 5 and 6, the second unit cell CE2 is defined as a diamond shape by the first inclined surface IS1, the second inclined surface IS2, the third inclined surface IS3, and the fourth inclined surface IS4. As a result, the first area (that includes the first length D1) of the interface between the second negative electrode coating layer AC2 and the second upper current-collecting layer UC2, in which lithium is precipitated during charging, is greater than the second area (that includes the second length D2) of the second positive electrode active material layer CA2. As a result, an alignment between the second positive electrode active material layer CA2 and the second upper current-collecting layer UC2 may be improved, and at the same time, a width of a migration path of lithium ions LI that migrate from the second positive electrode active material layer CA2 to the second upper current-collecting layer UC2 during charging may be expanded, resulting in uniform formation of the lithium metal layer LM between the second upper current-collecting layer UC2 and the second negative electrode coating layer AC2 during charging to improve the battery capacity and to suppress a short circuit between the positive electrode and negative electrode.

That is, the alignment between the second positive electrode active material layer CA2 and the second upper current-collecting layer UC2 may be improved, and at the same time, the migration path of lithium ions LI that migrate from the second positive electrode active material layer CA2 to the second upper current-collecting layer UC2 during charging may be expanded, resulting in the second unit cell CE2 in which the lithium metal layer LM is uniformly formed on the surface of the second upper current-collecting layer UC2 during charging to improve the battery capacity and to suppress a short circuit between the positive electrode and the negative electrode.

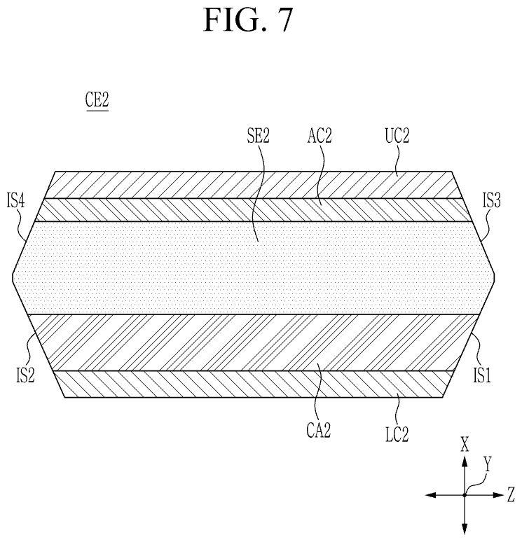

FIG. 7 is a longitudinal cross-sectional view showing an example of the second unit cell of the all-solid-state secondary battery according to an embodiment.

Referring to FIG. 7, the second unit cell CE2 according to an example may include the second lower current-collecting layer LC2, the second positive electrode active material layer CA2, the second solid electrolyte layer SE2, the second upper current-collecting layer UC2, the second negative electrode coating layer AC2, the first inclined surface IS1, the second inclined surface IS2, the third inclined surface IS3, and the fourth inclined surface IS4.

As illustrated in FIG. 7, the first inclined surface IS1 may have substantially the same area and length as those of the third inclined surface IS3. The second inclined surface IS2 may have substantially the same area and length as those of the fourth inclined surface IS4. An area from one end portion of the second solid electrolyte layer SE2 in contact with the first inclined surface IS1 and the third inclined surface IS3 to the other end portion of the second solid electrolyte layer SE2 in contact with the second inclined surface IS2 and the fourth inclined surface IS4 may be greater than an area of the second positive electrode active material layer CA2.

The first inclined surface IS1, the second inclined surface IS2, the third inclined surface IS3, and the fourth inclined surface IS4 make the area from one end portion to the other end portion of the second solid electrolyte layer SE2 of the second unit cell CE2 greater than the area of the second positive electrode active material layer CA2. As a result, alignment between the second positive electrode active material layer CA2 and the second upper current-collecting layer UC2 may be improved, and at the same time, a width of a migration path of lithium ions that migrate from the second positive electrode active material layer CA2 to the second upper current-collecting layer UC2 during charging may be expanded, resulting in uniform formation of the lithium metal layer between the second upper current-collecting layer UC2 and the second negative electrode coating layer AC2 during charging to improve the battery capacity and to suppress a short circuit between the positive electrode and negative electrode.

That is, the alignment between the second positive electrode active material layer CA2 and the second upper current-collecting layer UC2 may be improved, and at the same time, the migration path of lithium ions that migrate from the second positive electrode active material layer CA2 to the second upper current-collecting layer UC2 during charging may be expanded, resulting in the second unit cell CE2 in which the lithium metal layer is uniformly formed on the surface of the second upper current-collecting layer UC2 during charging to improve the battery capacity and to suppress a short circuit between the positive electrode and the negative electrode.

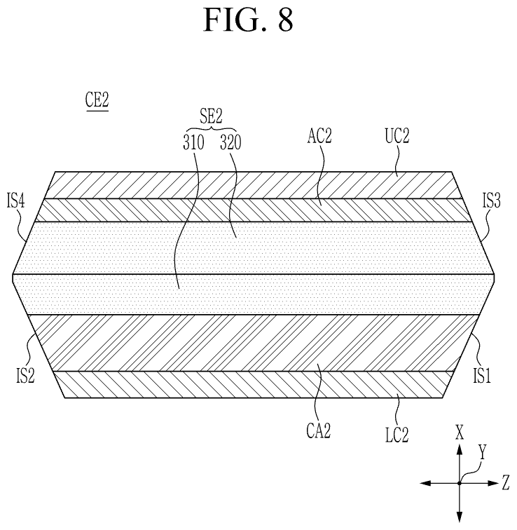

FIG. 8 is a longitudinal cross-sectional view showing another example of the second unit cell of the all-solid-state secondary battery according to an embodiment.

Referring to FIG. 8, the second unit cell CE2 according to another example may include the second lower current-collecting layer LC2, the second positive electrode active material layer CA2, the second solid electrolyte layer SE2, the second upper current-collecting layer UC2, the second negative electrode coating layer AC2, the first inclined surface IS1, the second inclined surface IS2, the third inclined surface IS3, and the fourth inclined surface IS4.

As illustrated in FIG. 8, the first inclined surface IS1 may have substantially the same area and length as those of the third inclined surface IS3. The second inclined surface IS2 may have substantially the same area and length as those of the fourth inclined surface IS4. An area from one end portion of the second solid electrolyte layer SE2 in contact with the first inclined surface IS1 and the third inclined surface IS3 to the other end portion of the second solid electrolyte layer SE2 in contact with the second inclined surface IS2 and the fourth inclined surface IS4 may be greater than an area of the second positive electrode active material layer CA2.

The second solid electrolyte layer SE2 may include a first sub-electrolyte layer 310 in contact with the second positive electrode active material layer CA2 and a second sub-electrolyte layer 320 in contact with the second negative electrode coating layer AC2. The first sub-electrolyte layer 310 may be formed on the surface of the second positive electrode active material layer CA2, the second sub-electrolyte layer 320 may be formed on the surface of the second negative electrode coating layer AC2, and the first sub-electrolyte layer 310 and the second sub-electrolyte layer 320 may be bonded to each other, resulting in the second unit cell CE2.

Even if the second unit cell CE2 is formed as a result of bonding between the first sub-electrolyte layer 310 and the second sub-electrolyte layer 320, the first inclined surface IS1, the second inclined surface IS2, the third inclined surface IS3, and the fourth inclined surface IS4 formed by a cutting process make the area from one end portion to the other end portion of the second solid electrolyte layer SE2 of the second unit cell CE2 greater than the area of the second positive electrode active material layer CA2 and improve alignment between the second positive electrode active material layer CA2 and the second upper current-collecting layer UC2, resulting in expansion of a width of a migration path of lithium ions that migrate from the second positive electrode active material layer CA2 to the second upper current-collecting layer UC2 during charging. As a result, the lithium metal layer may be formed uniformly between the second upper current-collecting layer UC2 and the second negative electrode coating layer AC2 during charging to improve the battery capacity and to suppress a short circuit between the positive electrode and negative electrode.

That is, the alignment between the second positive electrode active material layer CA2 and the second upper current-collecting layer UC2 may be improved, and at the same time, the migration path of lithium ions that migrate from the second positive electrode active material layer CA2 to the second upper current-collecting layer UC2 during charging may be expanded, resulting in the second unit cell CE2 in which the lithium metal layer is uniformly formed on the surface of the second upper current-collecting layer UC2 during charging to improve the battery capacity and to suppress a short circuit between the positive electrode and the negative electrode.

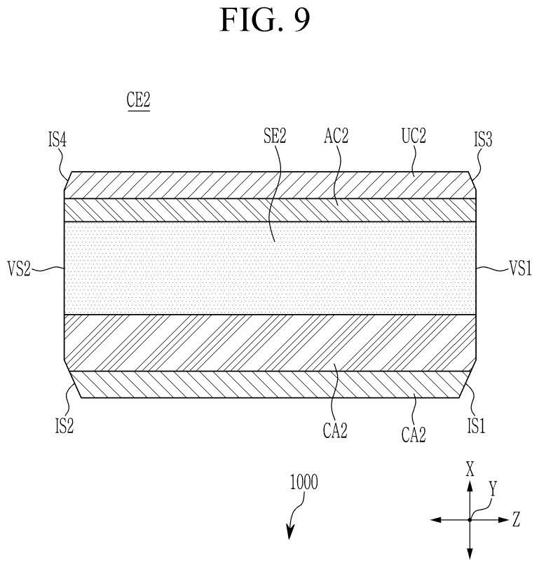

FIG. 9 is a longitudinal cross-sectional view showing still another example of the second unit cell of the all-solid-state secondary battery according to an embodiment.

Referring to FIG. 9, the second unit cell CE2 according to still another example may include the second lower current-collecting layer LC2, the second positive electrode active material layer CA2, the second solid electrolyte layer SE2, the second upper current-collecting layer UC2, the second negative electrode coating layer AC2, the first inclined surface IS1, the second inclined surface IS2, the third inclined surface IS3, and the fourth inclined surface IS4.

The first inclined surface IS1 may have substantially the same area and length as those of the third inclined surface IS3. The second inclined surface IS2 may have substantially the same area and length as those of the fourth inclined surface IS4. At least one of the first inclined surface IS1 and the third inclined surface IS3 may include a first vertical surface VS1 positioned at one end portion of the second solid electrolyte layer SE2, and at least one of the second inclined surface IS2 and the fourth inclined surface IS4 may include a second vertical surface VS2 positioned at the other end portion of the second solid electrolyte layer SE2. The first vertical surface VS1 and the second vertical surface VS2 may be formed by known various cutting processes.

The first inclined surface IS1, the second inclined surface IS2, the third inclined surface IS3, the fourth inclined surface IS4, the first vertical surface VS1, and the second vertical surface VS2 formed by the cutting process improve alignment between the second positive electrode active material layer CA2 and the second upper current-collecting layer UC2, thereby suppressing a migration path of lithium ions that migrate from the second positive electrode active material layer CA2 to the second upper current-collecting layer UC2 during charging from being non-uniform. As a result, a lithium metal layer may be formed uniformly between the second upper current-collecting layer UC2 and the second negative electrode coating layer AC2 during charging, thereby improving the battery capacity and suppressing a short circuit between the positive electrode and the negative electrode.

That is, the alignment between the second positive electrode active material layer CA2 and the second upper current-collecting layer UC2 may be improved to make a migration path of lithium ions that migrate from the second positive electrode active material layer CA2 to the second upper current-collecting layer UC2 during charging uniform, resulting in the second unit cell CE2 in which the lithium metal layer is uniformly formed on the surface of the second upper current-collecting layer UC2 during charging to improve the battery capacity and to suppress a short circuit between the positive electrode and the negative electrode.

As an example, there is provided an all-solid-state secondary battery 1000 including the first unit cell CE1 and the second unit cell CE2, in which alignment between a positive electrode active material layer and a negative electrode current-collecting layer is improved, and at the same time, a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode.

In addition, there is provided the all-solid-state secondary battery 1000 in which the plurality of unit cells form a bi-cell structure even if the first unit cell CE1 and the second unit cell CE2, which are a plurality of unit cells, include inclined surfaces that improve the battery capacity, and at the same time, suppress a short circuit between a positive electrode and a negative electrode.

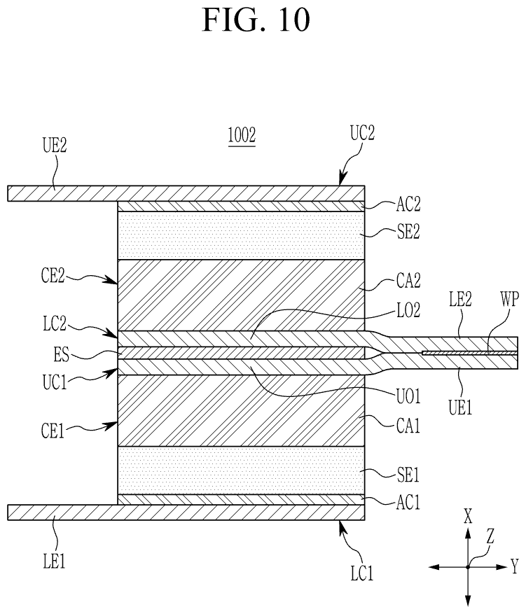

Below, an all-solid-state secondary battery according to another embodiment will be described with reference to FIG. 10. Hereinafter, parts that are different from the all-solid-state secondary battery according to the aforementioned embodiment will be described.

FIG. 10 is a longitudinal cross-sectional view showing a side of an all-solid-state secondary battery according to another embodiment.

Referring to FIG. 10, an all-solid-state secondary battery 1002 according to another embodiment may include the first unit cell CE1, the second unit cell CE2, and an elastic sheet ES stacked in the first direction (X) to form a bi-cell structure.

The first unit cell CE1 may include the first lower current-collecting layer LC1, the first negative electrode coating layer AC1, the first solid electrolyte layer SE1, the first positive electrode active material layer CA1, and the first upper current-collecting layer UC1 sequentially stacked in the first direction (X). The second unit cell CE2 may be positioned on the first upper current-collecting layer UC1 of the first unit cell CE1 with the elastic sheet ES interposed therebetween. The second unit cell CE2 may include the second lower current-collecting layer LC2, the second positive electrode active material layer CA2, the second solid electrolyte layer SE2, the second negative electrode coating layer AC2, and the second upper current-collecting layer UC2 sequentially stacked in the first direction (X).

The elastic sheet ES may be positioned between the first unit cell CE1 and the second unit cell CE2. The elastic sheet ES may be positioned between the first upper overlap portion UO1 of the first upper current-collecting layer UC1 of the first unit cell CE1 and the second lower overlap portion LO2 of the second lower current-collecting layer LC2 of the second unit cell CE2. The elastic sheet ES may be in contact with the first upper overlapping portion UO1 of the first upper current-collecting layer UC1 and the second lower overlapping portion LO2 of the second lower current-collecting layer LC2. The elastic sheet ES may include any suitable conductive elastic material, e.g., a conductive polymer.

The first unit cell CE1 and the second unit cell CE2 may be pressed toward each other, and the elastic sheet ES may be positioned between the first unit cell CE1 and the second unit cell CE2, so that a damage to the first unit cell CE1 and the second unit cell CE2 due to pressure may be suppressed, and at the same time, a contact area between the first unit cell CE1 and the second unit cell CE2 may be increased by elastic restoring force of the elastic sheet ES, leading to improvements in battery reliability and battery performance of the all-solid-state secondary battery 1002. As an example, there is provided an all-solid-state secondary battery 1002 including the first unit cell CE1 and the second unit cell CE2 in which alignment between a positive electrode active material layer and a negative electrode current-collecting layer is improved, and at the same time, a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode.

In addition, even if the first unit cell CE1 and the second unit cell CE2, which are a plurality of unit cells, include inclined surfaces that improve the battery capacity, and at the same time, suppress a short circuit between a positive electrode and a negative electrode, the all-solid-state secondary battery 1002 in which the plurality of unit cells form a bi-cell structure is provided. In addition, the elastic sheet ES is positioned between the first unit cell CE1 and the second unit cell CE2, so that a damage to the first unit cell CE1 and the second unit cell CE2 due to pressure is suppressed, and at the same time, a contact area between the first unit cell CE1 and the second unit cell CE2 is increased by elastic restoring force of the elastic sheet ES, resulting in the all-solid-state secondary battery 1002 with improved battery reliability and battery performance.

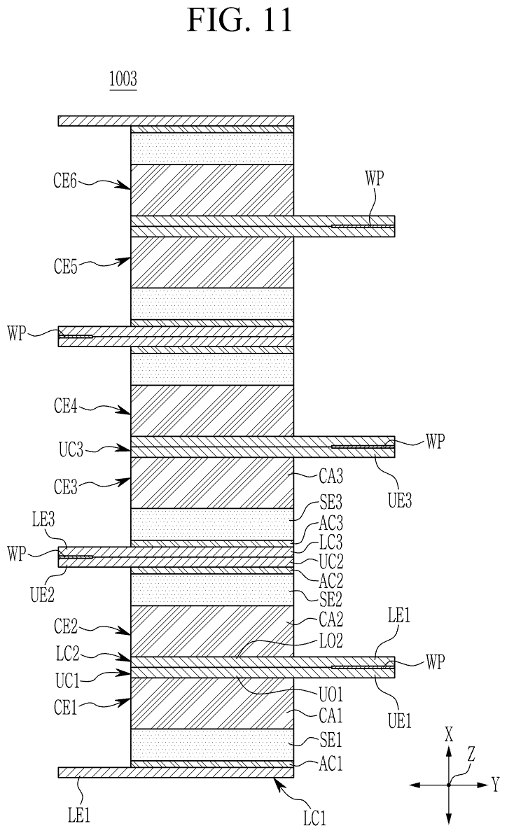

Below, an all-solid-state secondary battery according to still another embodiment will be described with reference to FIG. 11. Hereinafter, only parts that are different from the all-solid-state secondary battery according to the aforementioned embodiment will be described.

FIG. 11 is a longitudinal cross-sectional view showing a side of an all-solid-state secondary battery according to another embodiment.

Referring to FIG. 11, an all-solid-state secondary battery 1003 may include the first unit cell CE1, the second unit cell CE2, a third unit cell CE3, a fourth unit cell CE4, a fifth unit cell CE5, and a sixth unit cell CE6 stacked in the first direction (X) to form a bi-cell structure.

The first unit cell CE1 may include the first lower current-collecting layer LC1, the first negative electrode coating layer AC1, the first solid electrolyte layer SE1, the first positive electrode active material layer CA1, and the first upper current-collecting layer UC1 sequentially stacked in the first direction (X). The second unit cell CE2 may be positioned on the first upper current-collecting layer UC1 of the first unit cell CE1. The second unit cell CE2 may include the second lower current-collecting layer LC2, the second positive electrode active material layer CA2, the second solid electrolyte layer SE2, the second negative electrode coating layer AC2, and the second upper current-collecting layer UC2 sequentially stacked in the first direction (X).

The third unit cell CE3 may have the same stack structure as that of the first unit cell CE1, and may include a third lower current-collecting layer LC3, a third negative electrode coating layer AC3, a third solid electrolyte layer SE3, a third positive electrode active material layer CA3, and a third upper current-collecting layer UC3 sequentially stacked in the first direction (X). The third lower current-collecting layer LC3 may be a negative electrode current-collecting layer.

The third lower current-collecting layer LC3 may include a third lower extension portion LE3 extending in the second direction (Y). The third lower extension portion LE3 may be welded to the second upper extension portion UE2 of the second upper current-collecting layer UC2 of the second unit cell CE2 by a weld portion WP. The third lower extension portion LE3 and the second upper extension portion UE2 may extend in an opposite direction to the first upper extension portion UE1 and the second lower extension portion LE2 with respect to the second direction (Y).

The third upper current-collecting layer UC3 may be a positive electrode current-collecting layer. The third upper current-collecting layer UC3 may include a third upper extension portion UE3 extending in the second direction (Y), and the third upper extension portion UE3 may be welded to the lower extension portion of the lower current-collecting layer of the fourth unit cell CE4 by a weld portion (WP).

The first lower current-collecting layer LC1, the second upper current-collecting layer UC2, and the third lower current-collecting layer LC3 may have negative electrodes of the same first polarity, and the first upper current-collecting layer UC1, the second lower current-collecting layer LC2, and the third upper current-collecting layer UC3 may have positive electrodes of the same second polarity. As an example, the first unit cell CE1, the second unit cell CE2, and the third unit cell CE3 may form a bi-cell structure.

The fourth unit cell CE4 and the sixth unit cell CE6 may each have the same stack structure as that of the second unit cell CE2, and the fifth unit cell CE5 may have the same stack structure as that of each of the first unit cell CE1 and the third unit cell CE3. As an example, the first unit cell CE1, the second unit cell CE2, the third unit cell CE3, the fourth unit cell CE4, the fifth unit cell CE5, and the sixth unit cell CE6 may form a bi-cell structure.

As an example, there is provided an all-solid-state secondary battery 1003 including a plurality of unit cells including the first unit cell CE1 and the second unit cell CE2, in which alignment between a positive electrode active material layer and a negative electrode current-collecting layer is improved, and at the same time, a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode.

In addition, there is provided the all-solid-state secondary battery 1003 in which the plurality of unit cells form a bi-cell structure even if the plurality of unit cells including the first unit cell CE1 and the second unit cell CE2, which are a plurality of unit cells, include inclined surfaces that improve the battery capacity, and at the same time, suppress a short circuit between a positive electrode and a negative electrode.

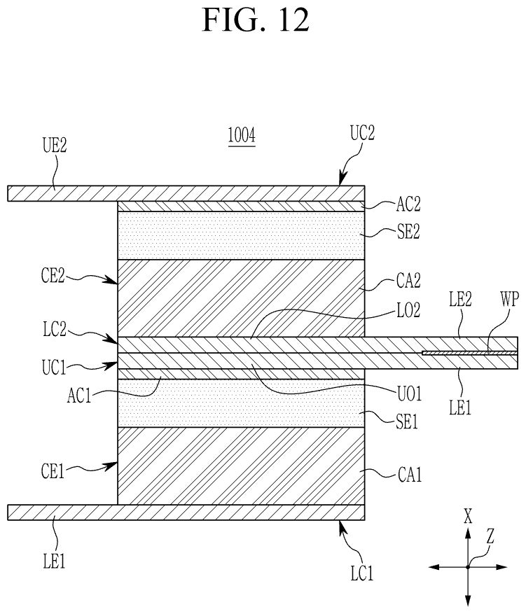

Below, an all-solid-state secondary battery according to yet another embodiment will be described with reference to FIG. 12. Hereinafter, only parts that are different from the all-solid-state secondary battery according to the aforementioned embodiment will be described.

FIG. 12 is a longitudinal cross-sectional view showing a side of an all-solid-state secondary battery according to yet another embodiment.

Referring to FIG. 12, an all-solid-state secondary battery 1004 according to yet another embodiment may include the first unit cell CE1 and the second unit cell CE2 stacked in the first direction (X) to form a bipolar cell structure.

The first unit cell CE1 may include the first lower current-collecting layer LC1, the first positive electrode active material layer CA1, the first solid electrolyte layer SE1, the first negative electrode coating layer AC1, and the first upper current-collecting layer UC1 sequentially stacked in the first direction (X). The first unit cell CE1 may have the same stack structure as that of the second unit cell CE2.

The first lower current-collecting layer LC1 may be a positive electrode current-collecting layer. The first upper current-collecting layer UC1 may be a negative electrode current-collecting layer. The first lower extension portion LE1 of the first upper current-collecting layer UC1 may be welded to the second lower extending portion LE2 of the second lower current-collecting layer LC2, which is a positive electrode current-collecting layer, by a weld portion WP.

The first lower current-collecting layer LC1 of the first unit cell CE1 and the second lower current-collecting layer LC2 of the second unit cell CE2 may have positive electrodes of the same first polarity, and the first upper current-collecting layer UC1 and the second upper current-collecting layer UC2 may have negative electrodes of the same second polarity. As an example, the first unit cell CE1 and the second unit cell CE2 may form a bipolar cell structure.

As an example, there is provided an all-solid-state secondary battery 1004 including the first unit cell CE1 and the second unit cell CE2, in which alignment between a positive electrode active material layer and a negative electrode current-collecting layer is improved, and at the same time, a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode.

In addition, there is provided the all-solid-state secondary battery 1004 in which the plurality of unit cells form a bipolar cell structure even if the first unit cell CE1 and the second unit cell CE2, which are a plurality of unit cells, include inclined surfaces that improve the battery capacity, and at the same time, suppress a short circuit between a positive electrode and a negative electrode.

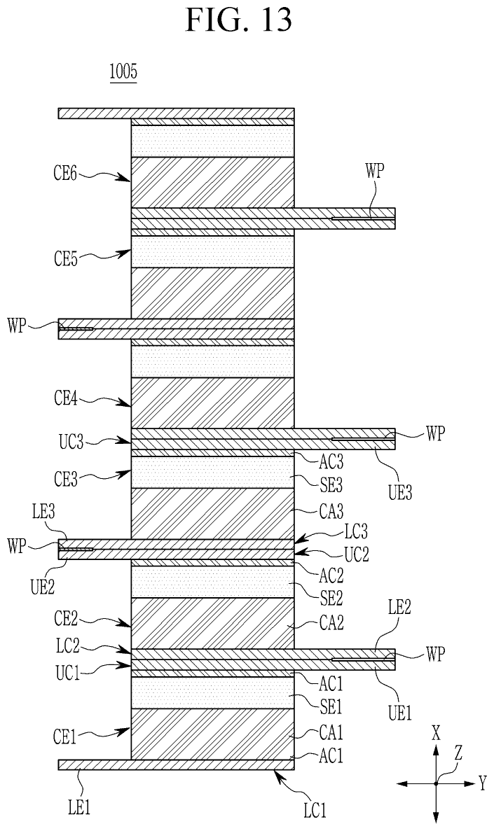

Below, an all-solid-state secondary battery according to still another embodiment will be described with reference to FIG. 13. Hereinafter, only parts that are different from the all-solid-state secondary battery according to the aforementioned embodiment will be described.

FIG. 13 is a longitudinal cross-sectional view showing a side of an all-solid-state secondary battery according to still another embodiment.

Referring to FIG. 13, an all-solid-state secondary battery 1005 according to still another embodiment may include the first unit cell CE1, the second unit cell CE2, the third unit cell CE3, the fourth unit cell CE4, the fifth unit cell CE5, and the sixth unit cell CE6 stacked in the first direction (X) to form a bipolar cell structure.

The first unit cell CE1 may include the first lower current-collecting layer LC1, the first positive electrode active material layer CA1, the first solid electrolyte layer SE1, the first negative electrode coating layer AC1, and the first upper current-collecting layer UC1 sequentially stacked in the first direction (X). The first unit cell CE1 may have the same stack structure as that of the second unit cell CE2.

The first lower current-collecting layer LC1 may be a positive electrode current-collecting layer. The first upper current-collecting layer UC1 may be a negative electrode current-collecting layer. The first lower extension portion LE1 of the first upper current-collecting layer UC1 may be welded to the second lower extending portion LE2 of the second lower current-collecting layer LC2, which is a positive electrode current-collecting layer, by a weld portion WP.

The third unit cell CE3 may include the third lower current-collecting layer LC3, the third positive electrode active material layer CA3, the third solid electrolyte layer SE3, the third negative electrode coating layer AC3, and the third upper current-collecting layer UC3 sequentially stacked in the first direction (X). The third unit cell CE3 may have the same stack structure as that of the second unit cell CE2.

The third lower current-collecting layer LC3 may be a positive electrode current-collecting layer. The third lower current-collecting layer LC3 may include the third lower extension portion LE3 extending in the second direction (Y). The third lower extension portion LE3 may be welded to the second upper extension portion UE2 of the second upper current-collecting layer UC2 of the second unit cell CE2 by a weld portion WP. The third lower extension portion LE3 and the second upper extension portion UE2 may extend in an opposite direction to the first upper extension portion UE1 and the second lower extension portion LE2 with respect to the second direction (Y).

The third upper current-collecting layer UC3 may be a negative electrode current-collecting layer. The third upper current-collecting layer UC3 may include a third upper extension portion UE3 extending in the second direction (Y), and the third upper extension portion UE3 may be welded to the lower extension portion of the lower current-collecting layer of the fourth unit cell CE4 by a weld portion (WP).

The first lower current-collecting layer LC1, the second lower current-collecting layer LC2, and the third lower current-collecting layer LC3 may have positive electrodes of the same first polarity, and the first upper current-collecting layer UC1 and the second upper current-collecting layer UC2, and the third upper current-collecting layer UC3 have negative electrodes of the same second polarity. As an example, the first unit cell CE1, the second unit cell CE2, and the third unit cell CE3 may form a bipolar cell structure.

The fourth unit cell CE4, the fifth unit cell CE5, and the sixth unit cell CE6 each have the same stack structure as that of the second unit cell CE2. As an example, the first unit cell CE1, the second unit cell CE2, the third unit cell CE3, the fourth unit cell CE4, the fifth unit cell CE5, and the sixth unit cell CE6 may form a bipolar cell structure.

As an example, there is provided an all-solid-state secondary battery 1005 including a plurality of unit cells including the first unit cell CE1 and the second unit cell CE2, in which alignment between a positive electrode active material layer and a negative electrode current-collecting layer is improved, and at the same time, a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode.

In addition, there is provided the all-solid-state secondary battery 1005 in which the plurality of unit cells form a bipolar cell structure even if the plurality of unit cells including the first unit cell CE1 and the second unit cell CE2, which are a plurality of unit cells, include inclined surfaces that improve the battery capacity, and at the same time, suppress a short circuit between a positive electrode and a negative electrode.

By way of summation and review, if alignment between respective layers is misaligned during manufacturing of an all-solid-state secondary battery, a lithium metal layer may be formed non-uniformly on a surface of a negative electrode current-collecting layer when charging the battery. If the lithium metal layer is formed non-uniformly on the surface of the current-collecting layer of the all-solid-state secondary battery, the battery capacity may decrease, or a crack may be generated in a solid electrolyte layer positioned between the negative electrode current-collecting layer and a positive electrode active material layer, causing a short circuit between a positive electrode and a negative electrode.

In contrast, embodiments provide an all-solid-state secondary battery in which alignment between a positive electrode active material layer and a negative electrode current-collecting layer is improved and a migration path of lithium ions migrating from the positive electrode active material layer to the negative electrode current-collecting layer during charging is expanded, resulting in uniform formation of a lithium metal layer on a surface of the negative electrode current-collecting layer during charging to improve the battery capacity and to suppress a short circuit between a positive electrode and a negative electrode. Furthermore, it is intended to provide an all-solid-state secondary battery in which a plurality of unit cells form a bi-cell structure or a bipolar cell structure, even if the plurality of unit cells include an inclined surface that improves the battery capacity and suppresses a short circuit between a positive electrode and a negative electrode.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state secondary battery, comprising:
a first unit cell including a first lower current-collecting layer, a first solid electrolyte layer, and a first upper current-collecting layer stacked in a first direction;
and a second unit cell on the first upper current-collecting layer of the first unit cell and including a second lower current-collecting layer, a second solid electrolyte layer, and a second upper current-collecting layer stacked in the first direction,
wherein the first upper current-collecting layer includes a first upper extension portion extending in a second direction intersecting with the first direction, and
wherein the second lower current-collecting layer includes a second lower extension portion extending in the second direction and welded to the first upper extension portion.

2. The all-solid-state secondary battery of claim 1, wherein:
the first upper extension portion does not overlap the first solid electrolyte layer and the second solid electrolyte layer in the first direction, and
the second lower extension portion does not overlap the first solid electrolyte layer and the second solid electrolyte layer in the first direction.

3. The all-solid-state secondary battery of claim 1, wherein:
the first upper current-collecting layer further includes a first upper overlapping portion extending from the first upper extension portion into a space between the first solid electrolyte layer and the second solid electrolyte layer, and
the second lower current-collecting layer further includes a second lower overlapping portion extending from the second lower extension portion into the space between the first solid electrolyte layer and the second solid electrolyte layer and overlapping the first upper overlapping portion in the first direction.

4. The all-solid-state secondary battery of claim 3, wherein the first upper overlapping portion of the first upper current-collecting layer is in contact with the second lower overlapping portion of the second lower current-collecting layer.

5. The all-solid-state secondary battery of claim 4, wherein the first upper overlapping portion of the first upper current-collecting layer and the second lower overlapping portion of the second lower current-collecting layer are not welded to each other.

6. The all-solid-state secondary battery of claim 3, further comprising an elastic sheet between the first upper overlapping portion of the first upper current-collecting layer and the second lower overlapping portion of the second lower current-collecting layer.

7. The all-solid-state secondary battery of claim 6, wherein the elastic sheet is in contact with the first upper overlapping portion of the first upper current-collecting layer and the second lower overlapping portion of the second lower current-collecting layer.

8. The all-solid-state secondary battery of claim 1, further comprising a third unit cell on the second upper current-collecting layer of the second unit cell and including a third lower current-collecting layer, a third solid electrolyte layer, and a third upper current-collecting layer stacked in the first direction,
wherein the second upper current-collecting layer includes a second upper extension portion extending in the second direction, and
wherein the third lower current-collecting layer includes a third lower extension portion extending in the second direction and welded to the second upper extension portion.

9. The all-solid-state secondary battery of claim 8, wherein the second upper extension portion and the third lower extension portion extend in an opposite direction to the first upper extension portion and the second lower extension portion with respect to the second direction.

10. The all-solid-state secondary battery of claim 8, wherein:
the first lower current-collecting layer, the second upper current-collecting layer, and the third lower current-collecting layer have a same first polarity, and
the first upper current-collecting layer, the second lower current-collecting layer, and the third upper current-collecting layer have a same second polarity.

11. The all-solid-state secondary battery of claim 10, wherein the first unit cell, the second unit cell, and the third unit cell define a bi-cell structure.

12. The all-solid-state secondary battery of claim 8, wherein:
the first lower current-collecting layer, the second lower current-collecting layer, and the third lower current-collecting layer have a same first polarity, and
the first upper current-collecting layer, the second upper current-collecting layer, and the third upper current-collecting layer have a same second polarity.

13. The all-solid-state secondary battery of claim 12, wherein the first unit cell, the second unit cell, and the third unit cell define a bipolar cell structure.

14. The all-solid-state secondary battery of claim 1, wherein the second unit cell further includes:
a positive electrode active material layer between the second lower current-collecting layer and the second solid electrolyte layer;
a negative electrode coating layer between the second solid electrolyte layer and the second upper current-collecting layer;
a first inclined surface extending from one end portion of the second lower current-collecting layer to one end portion of the second solid electrolyte layer;
a second inclined surface extending from another end portion of the second lower current-collecting layer to another end portion of the second solid electrolyte layer;
a third inclined surface extending from one end portion of the second upper current-collecting layer to the one end portion of the second solid electrolyte layer; and
a fourth inclined surface extending from another end portion of the second upper current-collecting layer to the other end portion of the second solid electrolyte layer.

15. The all-solid-state secondary battery of claim 14, wherein an area of an interface between the second upper current-collecting layer and the negative electrode coating layer is greater than an area of the positive electrode active material layer.

16. The all-solid-state secondary battery of claim 15, wherein the area of the interface between the second upper current-collecting layer and the negative electrode coating layer is greater than an area of the second lower current-collecting layer.

17. The all-solid-state secondary battery of claim 15, wherein, during charging, a lithium metal layer is between the second upper current-collecting layer and the negative electrode coating layer.

18. The all-solid-state secondary battery of claim 17, wherein an area of the lithium metal layer is greater than the area of the positive electrode active material layer.

19. The all-solid-state secondary battery of claim 18, wherein the area of the lithium metal layer is greater than the area of the second lower current-collecting layer.

20. The all-solid-state secondary battery of claim 17, wherein:
one end portion of the lithium metal layer divides the third inclined surface, and
another end portion of the lithium metal layer divides the fourth inclined surface.
